(19) United States
(12) Patent Application Publication
(10) Pub. No.: US 2010/0020125 A1
(43) Pub. Date: Jan. 28, 2010

(54) FLUID EJECTION APPARATUS

(75) Inventor: Hisashi MIYAZAWA, Okaya-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/507,133

(22) Filed: Jul. 22, 2009

(30) Foreign Application Priority Data
Jul. 23, 2008 (JP) 2008-189459

(51) Int. Cl. B41J 2/165

(52) U.S. Cl. 347/30

(57) ABSTRACT

A fluid ejection apparatus that ejects fluid from an ejection nozzle in an ejection head includes a fluid receiver that has a concave portion for accommodating the ejected fluid and defines a closed space around the ejection nozzle when the concave portion contacts the ejection head. Suction pumps suck the fluid in the concave portion through suction ports in the concave portion. A fluid suction unit sucks the fluid in the ejection head through the ejection nozzle by operating the suction pumps such that the concave portion contacts the ejection head. An air suction unit sucks the air and the fluid in the concave portion of the fluid receiver after completion of suction of the fluid in the ejection head, by allowing at least one suction pump to reverse the air flow in collaboration with the operation of at least one other suction pump.

### BACKGROUND

1. Technical Field

The present invention relates to an apparatus that ejects a fluid from an ejection head.

2. Related Art

An inkjet printer can print an image of high quality by ejecting an accurate amount of ink to an appropriate position from a fine ejection nozzle. Using this technology, an electrode, a sensor, or a bio-chip may be manufactured by ejecting various fluids onto a substrate instead of ink.

In this technology, a dedicated ejection head is used to eject an accurate amount of fluid such as ink to an appropriate position. Since the viscosity of fluid such as ink supplied to the ejection head increases over time, making it difficult to eject the fluid appropriately, a cap comes in contact with the ejection head to close the periphery of the ejection nozzle when the fluid is not ejected and thus suppresses an increase in the viscosity of the fluid. The state in which the cap is in contact with the ejection head in order to suppress an increase in the viscosity of the fluid is referred to as a “capping state.”

The viscosity of the fluid in the ejection head gradually increases even in a capping state. As such, if the viscosity of the fluid increases, an operation (cleaning operation) which involves compulsorily drawing out the fluid whose viscosity has increased in the ejection head from the ejection nozzle is performed through negative pressure created in the cap by a suction pump while the cap is in contact with the ejection head. Since the sucked fluid is attached to the periphery of the ejection nozzle after the cleaning operation, the ejection nozzle may be blocked if this state continues. After the cleaning operation, an operation (wiping operation) of wiping the fluid attached to the periphery of the ejection nozzle is performed after the cap is separated from the ejection head. Then, the cap comes in contact with the ejection head, returning to the capping state.

However, since the cap on which the cleaning operation has been performed is filled with the fluid drawn out from the ejection head, the fluid filled in the cap is leaked out when the cap is separated from the ejection head. Therefore, Japanese Patent Laid-Open No. 2001-342975 suggested that an air opening valve for introducing air into the cap is provided in advance in the cap to suck air by opening the air opening valve after the completion of a cleaning operation, performing an air sucking operation of introducing air by opening the air opening valve with a suction pump being operated, and performing a wiping operation to achieve a capping state.

Since the viscosity of fluid in the ejection head increases, it is difficult to draw out the fluid. In order to overcome this, it is preferable for the magnitude of the negative pressure of the suction pump to be as large as possible.

However, if the magnitude of the negative pressure in the cap is increased by the suction pump, air flows in with a rush and generates bubbles in the cap when an air sucking operation is performed by the opening the air opening valve. The bubbles can then be introduced into the ejection nozzle, and in this case the fluid cannot be normally ejected.

### SUMMARY

An advantage of some aspects of the invention is that it provides a fluid ejection apparatus that avoids the abnormal ejection of fluid due to bubbles generated during an air sucking operation while also generating a large magnitude of negative pressure in the cap.

According to a first aspect of the invention, there is provided a fluid ejection apparatus that ejects a fluid from an ejection nozzle formed in an ejection head, comprising: a fluid receiver that has a concave portion for accommodating the fluid from the ejection nozzle, and defines a closed space around the ejection nozzle when the concave portion comes in contact with the ejection head; a plurality of suction pumps that suck the fluid in the concave portion of the fluid receiver through suction ports provided in the concave portion of the fluid receiver; a fluid suction unit that sucks the fluid in the ejection head through the ejection nozzle by operating the suction pumps in a state in which the concave portion of the fluid receiver comes in contact with the ejection head; and an air suction unit that, after completion of suction of the fluid in the ejection head, sucks the air together with the fluid in the concave portion of the fluid receiver by allowing at least one suction pump to reverse the air flow in collaboration with the operating of at least one other suction pump.

In the fluid ejection apparatus, the fluid from the ejection nozzle can be received into the concave portion provided in the fluid receiver. A plurality of suction ports are provided in the concave portion and are each connected to suction pumps. A fluid sucking operation of sucking fluid in the ejection head from the ejection nozzle is allowed by operating the suction pumps after the concave portion of the fluid receiver comes in contact with the ejection head. The fluid sucking operation is completed by performing an air sucking operation in which at least one suction pump is operated in a state in which air can be reversed by at least one other suction pump.

Since a large magnitude of negative pressure can be generated in the concave portion of the fluid receiver by simultaneously operating the suction pumps, the fluid can be drawn out from the ejection nozzle even after the viscosity of the fluid in the ejection head has increased. After the completion of the fluid sucking operation, the fluid in at least one suction pump is reversed to reduce the magnitude of the negative pressure in the concave portion of the fluid receiver when the air in the at least one suction pump is reversible. After this, an air sucking operation is performed, such that it is possible to avoid abnormal ejection of the fluid due to bubbles generated during the air sucking operation.

The fluid ejection apparatus includes a waste fluid tank in which the fluid sucked from the ejection nozzle is gathered. The waste fluid tank and discharge ports of the suction pumps may be connected to each other by a waste fluid tube.

In this way, the fluid drawn out from the suction pump may be properly introduced into the waste fluid tank.

The waste fluid tube of the suction pump allowed to reverse air flow when air is being sucked, is inserted into the waste fluid tank in a shallower position than the waste fluid tube of another suction pump.

In this way, even when the tip end of the waste fluid tube of another suction pump (performing a suction operation) is submerged in the fluid in the waste fluid tank, the tip end of the waste fluid tube of the suction pump through which air is reversible is not submerged in the fluid, which enables the suction of air and the performing of an air sucking operation.

### BRIEF DESCRIPTION OF THE DRAWINGS

The invention will be described with reference to the accompanying drawings, wherein like numbers reference like elements.

FIG. 1 is a perspective view schematically illustrating an example of a fluid ejection apparatus, i.e. an inkjet printer according to an embodiment of the invention.

FIG. 2 is a bottom view of a head assembly of FIG. 1.

FIG. 3 is a perspective view schematically illustrating a maintenance mechanism of FIG. 1.

FIG. 4 is a view illustrating the maintenance mechanism of FIG. 1 in more detail.

FIGS. 5A to 5C are views for explaining the maintenance operation of the inkjet printer according to the embodiment of the invention.

### DESCRIPTION OF EXEMPLARY EMBODIMENTS

Hereinafter, an exemplary embodiment of the invention will be described in detail with reference to the accompanying drawings.

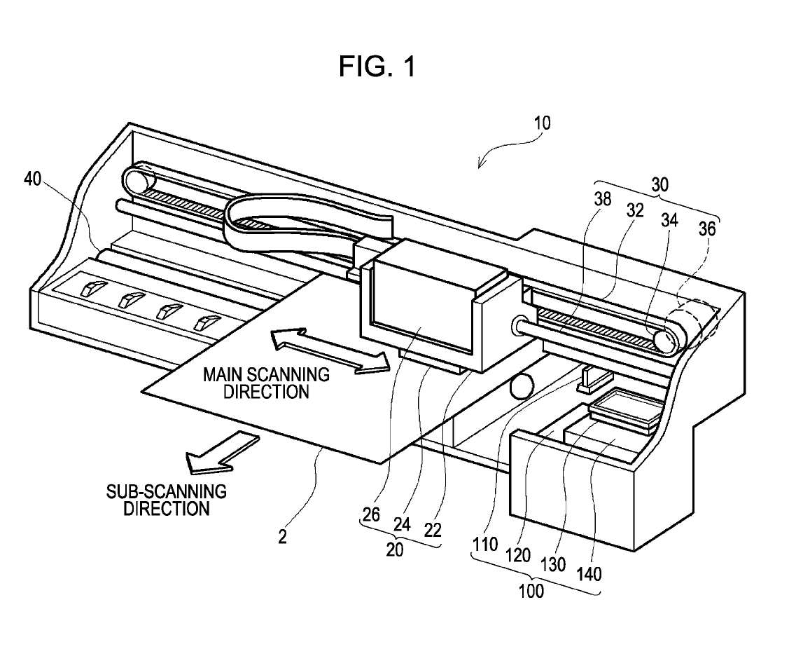

FIG. 1 is a perspective view schematically illustrating an example of a fluid ejection apparatus, i.e. an inkjet printer according to an embodiment of the invention. As illustrated in FIG. 1, the inkjet printer 10 includes a carriage 20 forming ink dots on a printing medium 2 while reciprocating in a main scanning direction, a drive mechanism 30 reciprocating the carriage 20, a platen roller 40 for feeding paper, i.e. the printing medium 2, and a maintenance mechanism 100 for maintaining a normal printing operation. The carriage 20 contains an ink cartridge 26 accommodating ink, a carriage case 22 to which the ink cartridge 26 is mounted, and a head assembly 24 mounted to the bottom (facing the printing medium 2) of the carriage case 22. As will be described below, the head assembly 24 includes a plurality of ejection heads for ejecting ink in order to eject only the accurate amount of ink in the ink cartridge 26 to the printing medium 2 from the ejection heads, thereby printing an image.

The drive mechanism 30 for reciprocating the carriage 20 includes a guide rail 38 installed in the main scanning direction, a timing belt 32 having a plurality of teeth on the inner surface thereof, a driving pulley 34 enmeshed with the timing belt 32, and a stepping motor 36 for driving the driving pulley 34. Some portions of the timing belt 32 are fixed to the carriage case 22 in order to move the carriage case 22 along the guide rail 38 when the timing belt 32 is driven. Since the timing belt 32 is enmeshed with the driving pulley 34, when the driving pulley 34 is driven by the stepping motor 36, the carriage case 22 can be precisely moved according to the driving amount of the stepping motor 36.

The plate roller 40 for feeding the printing medium 2 is driven by a driving motor or gear mechanism (not shown) to feed the printing medium 2 by a predetermined amount in a sub-scanning direction.

The maintenance mechanism 100 is provided in a region called a home position other than a factor region, and includes a wiper blade 110 wiping out an ejection head provided on the bottom surface of the head assembly 24, a cap 130 pressed by the bottom surface of the head assembly 24 to define a closed space with the ejection head, a suction pump unit 140 provided under the cap 130, a waste fluid tank 120 provided under the suction pump unit 140. When a printing operation is not carried out, a closed space is defined between the cap 130 and the ejection head mounted to the head assembly 24 by moving the carriage 20 to the home position and pressing the cap 130 against the bottom surface of the head assembly 24. As will be described in detail, although a fine ejection nozzle provided in the ejection head to eject ink is opened, the viscosity of the ink in the ejection head can be prevented from increasing due to the drying of ink by defining a closed space by the pressing of the cap 130.

However, even when ink is prevented from being dried by pressing the cap 130, moisture or volatile substances in the ink gradually decrease over a long period of time which change the property of the ink (in particular, increase the viscosity of the ink). Therefore, when the viscosity of ink minutely increases, the property of the ink in the head assembly 24 is returned to a normal state by moving the head assembly 24 to the position of the cap 130 and performing an operation (flashing operation) of ejecting the ink whose viscosity has increased. Meanwhile, when ink cannot be recovered by a flashing operation or the viscosity of ink has increased due to non use of the inkjet printer 10 over a long period of time, an operation (cleaning operation) of drawing the ink in the head assembly 24 out of an ejection nozzle is performed by operating the suction pump embedded in the suction pump unit 140 and creating negative pressure in the closed space. The ink discharged by a flashing operation or a cleaning operation gathers in the waste fluid tank 120. Since ink is attached to a surface of an ejection head provided in the head assembly 24 after a cleaning operation, it may cause the blocking of an ejection nozzle or a filthy surface of a printing medium if it is left in that state. Therefore, the ink attached to a surface of an ejection head is wiped off by the wiper blade 110 after a cleaning operation.

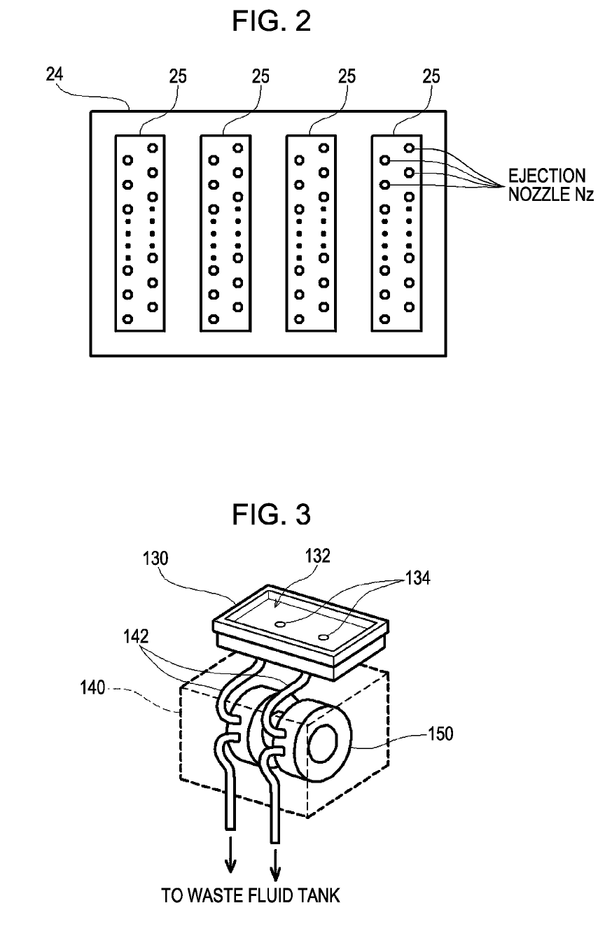

FIG. 2 is a bottom view of a head assembly of FIG. 1. As illustrated in FIG. 2, a plurality of ejection heads 25 are provided on the bottom surface of the head assembly 24 and small ejection nozzles Nz for ejecting ink are arranged in each ejection head 25 in evenly spaced intervals. A predetermined number of ejection heads 25 (two ejection heads in the illustrated example) forms a set and ink of yellow (Y), magenta (M), cyan (C), and black (K) is ejected from each nozzle Nz.

FIG. 3 is a perspective view schematically illustrating a maintenance mechanism of FIG. 1. As illustrated in FIG. 3, a rectangular concave portion 132 is formed on the upper surface of the cap 130 (facing the head assembly 24) to allow ink discharged from the ejection head 25 to be received into the concave portion 132 during a flashing operation or a cleaning operation. Two suction ports 134 are provided on the bottom surface of the concave portion 132.

Two suction pumps 150 are accommodated in the suction pump unit 140. One suction pump 150 is connected to a suction port 134 provided in the concave portion 132 of the cap 130 via a suction tube 142, and the other suction pump 150 is connected to a suction port 134 via a suction tube 142. The two suction pumps 150 are connected to a motor (not shown) such that when they are simultaneously operated, ink can be sucked from the two suction ports 134 provided in the concave portion 132 of the cap 130. Meanwhile, only one suction pump 150 may be independently operated.

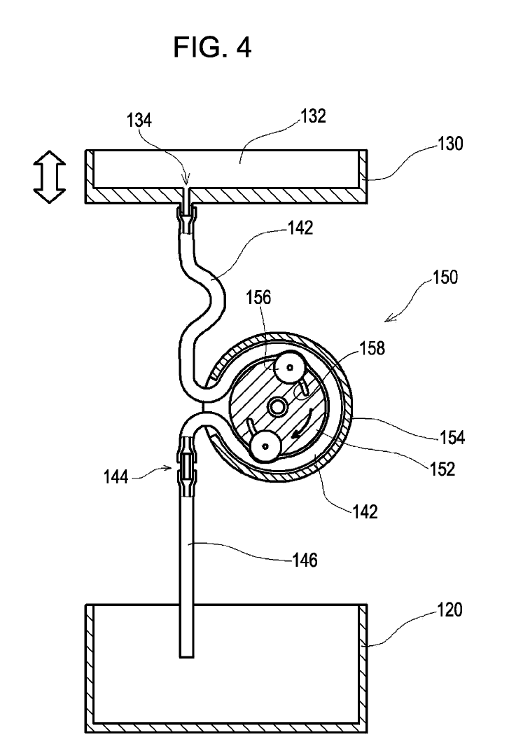

FIG. 4 is a view illustrating the maintenance mechanism of FIG. 1 in more detail. Briefly, a suction pump 150 has a configuration where a suction tube 142 is wound around the outer periphery of a rotary disk 152, and the rotary disk 152 and the suction tube 142 are accommodated in a case 154. Although the suction tube 142 does not completely loop around the outer periphery of the rotary disk 152 for clarity in FIG. 4, it completely loops around the outer periphery of the rotary disk 152 in reality.

Disk-shaped top members 156 are rotatably provided in the rotary disk 152 and are supported within guide grooves 158. Each guide groove 158 has an angle with respect to the outer periphery of the rotary disk 152 such that one end thereof is closer to the outer periphery of the rotary disk 152 and the opposite end thereof is further away from the outer periphery of the rotary disk 152. Therefore, when each top member 156 is located on one side of the guide groove 158, it protrudes significantly from the outer periphery of the rotary disk 152. On the other hand, when the top member 156 is located on the opposite side of the guide groove 158, it protrudes by a small degree from the outer periphery of the rotary disk 152.

The operation of the suction pump 150 will be described in detail. The rotary disk 152 is rotated in the forward direction (indicated by an arrow in the figure) by the operating of a motor (not shown). Then, the two top members 156 provided in the rotary disk 152 are moved to one side of the guide groove 158 by a frictional force from the suction tube 142 and protruding significantly from the outer periphery of the rotary disk 152. FIG. 4 illustrates a state in which the top members protruding significantly from the outer periphery of the rotary disk 152. As illustrated in FIG. 4, the suction tube 142 is closed when pressed by a significantly protruding top member 156.

In this state, when the rotary disk 152 is rotated in the forward direction, the pressed position of the suction tube 142 is moved as the top member 156 moves. As a result, ink in the suction tube 142 is pushed downward and is discharged into the waste fluid tank 120 through the waste ink tube 146 from the discharge port 144 of the suction pump 150. Therefore, as illustrated in FIG. 4, if the rotary disk 152 is rotated in the forward direction in a state in which the upstream side of the suction tube 142 is connected to the suction port 134 of the cap 130 and the downstream side of the suction tube 142 is connected to the waste tube 146 through the discharge port 144, the ink gathered in the concave portion 132 of the cap 130 can be discharged into the waste fluid tank 120.

On the other hand, when the rotary disk 152 is rotated in the backward direction, the top member 156 is moved to the opposite side of the guide groove 158 by the frictional force from the suction tube 142. As described above, since the opposite side of the guide groove 158 is further away from the outer periphery of the rotary disk 152, the top member 156 protrudes by a smaller degree as it moves from the one side to the opposite side of the guide groove 158. The top member 156 is in contact with the suction tube 142, but does not close the suction tube 142 on the opposite side of the guide groove 158. Therefore, the exit of the waste ink tube 146 is linked with the suction port 134 of the cap 130 through the suction tube 142 when the rotary disk 152 is rotated in the backward direction.

As described above, two suction pumps 150 are mounted to the inkjet printer 10 according to the embodiment of the invention. As a result, as will be described below, the cleaning operation and the air sucking operation are performed in a particular way. Hereinafter, the cleaning operation and the air sucking operation of the inkjet printer 10 will be described in detail. The two operations, i.e. the cleaning operation and the air sucking operation are referred to as a maintenance operation.

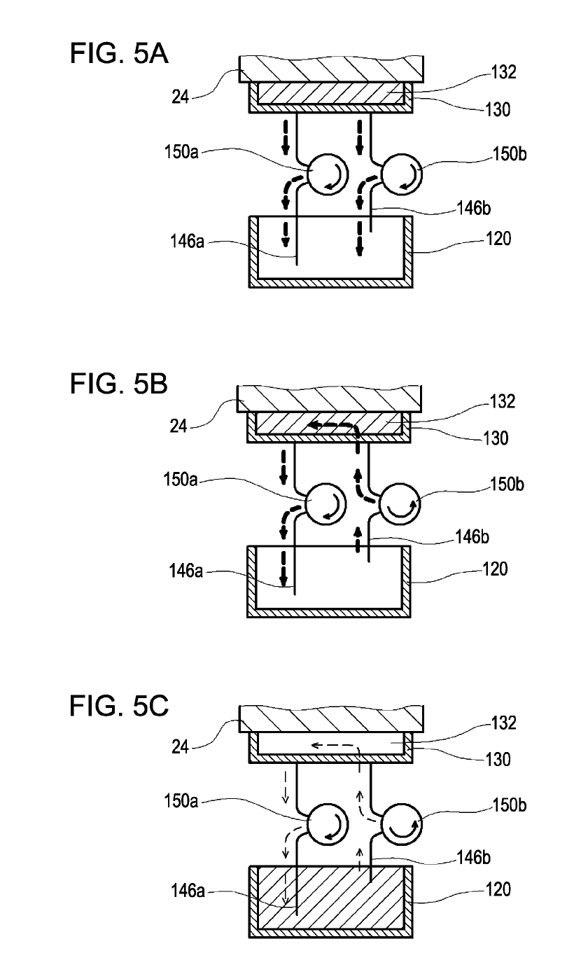

FIGS. 5A to 5C are views for explaining the maintenance operation of the inkjet printer according to the embodiment of the invention. FIG. 5A illustrates an initial operation of the maintenance operation, i.e. the cleaning operation. In the cleaning operation, the suction pump 150 is operated with a closed space being formed by forcing the cap 130 to come in contact with the bottom side of the head assembly 24. As described above, since two suction pumps 150 are mounted to the inkjet printer 10 according to the embodiment of the invention, they are respectively referred to as suction pump 150a and suction pump 150b for clarity when they need to be distinguished.

As illustrated in FIG. 5A, when the two suction pumps 150a and 150b are rotated in the forward direction, the negative pressures generated by the suction pumps 150a and 150b are simultaneously applied to the concave portion 132 of the cap 130 and this sucks ink from the ejection heads 25. The sucked ink gathers in the concave portion 132 of the cap 130 and is discharged into the waste fluid tank 120 by the suction pumps 150a and 150b. In FIG. 5a, the oblique lines in the concave portion 132 of the cap 130 show that the concave portion 132 is filled with ink.

In this way, since ink is sucked using two suction pumps 150a and 150b, a large magnitude of negative pressure is produced in the concave portion 132 of the cap 130, and as a result, the head assembly 24 can return to a normal state by the drawing out the ink whose viscosity has increased, even after the viscosity of the ink in the head assembly 24 has increased.

If the ink whose viscosity has increased in the head assembly 24 is drawn out through the cleaning operation, the cap 130 is separated from the head assembly 24 to perform the wiping operation, and through introduction of air, an air sucking operation of discharging all the ink in the concave portion 132 of the cap 130 is started. However, since two suction pumps 150a and 150b are simultaneously operated in the inkjet printer 10 to create a large magnitude of negative pressure in the concave portion 132 of the cap 130, bubbles are generated in the concave portion 132 of the cap 130 by the air introduced during an air sucking operation, mix in the ejection nozzle and hamper normal ejection of ink. Therefore, the inkjet printer 10 according to the embodiment of the invention performs the following air sucking operation.

First, in a state in which one suction pump 150a is being rotated forward, the other pump 150b is rotated backward. As described above referring to FIG. 4, an upstream side (connected to the concave portion 132) of the suction pump 150b that has been rotated backward is linked with the downstream side (connected to the waste fluid tank 120) thereof. Here, since a large magnitude of negative pressure is generated in the concave portion 132 of the cap 130 and a negative pressure is not generated in the waste fluid tank 120, the ink in the suction tube 142 and the waste ink tube 146 of the suction pump 150b is reversed and introduced into the concave portion 132 of the cap 130. As a result, the magnitude of the negative pressure of the concave portion 132 is reduced. FIG. 5B illustrates the suction pump 150b that reduces the magnitude of the negative pressure in the concave portion 132 by reversing the ink when it is rotated backward. In FIG. 5B, after the upstream side and downstream side of the suction pump 150b that has been rotated backward are linked with each other, the rotation of the suction pump 150b may be stopped.

In this way, if one suction pump 150a remains rotating forward and the other suction pump 150b remains rotating backward (or remains stopped after rotated backward), all the ink in the suction pump 150b that is rotated backward is reversed, and the so-called air sucking operation is started by reversing air from the waste fluid tank 120. That is, if the suction pump 150a that is rotating forward sucks out the ink in the concave portion 132 of the cap 130, the ink is reversed and sucked in through the other suction pump 150b by the negative pressure.

In the inkjet printer 10 according the embodiment of the invention, since the ink in the suction pump 150b rotated backward is reversed and the negative pressure in the concave portion 132 of the cap 130 is reduced before an air sucking operation, the air introduced during the air sucking operation does not generate bubbles in the concave portion 132 of the cap 130. As illustrated in FIG. 5, the waste ink tube 146b connected to the suction pump 150b rotated backward is inserted in a shallower position of the waste fluid tank 120 than the waste ink tube 146a of the suction pump 150a. Therefore, even if the tip end of the waste tube 146a of the suction pump 150a rotated forward is submerged in the ink, the tip end of the waste ink tube 146b of the suction pump 150b rotated backward is not submerged in the ink, which allows for the suction of the ink.

FIG. 5C illustrates an operation of sucking all the ink in the concave portion 132 of the cap 130. The dashed lines represents that air reversed from the suction pump 150b is drawn out by the suction pump 150a. In this state, the air sucking operation is completed by stopping the suction pumps 150a and 150b. Thereafter, a wiping operation is performed after the cap 130 is lowered to be separated from the head assembly 24.

As described above, in the inkjet printer 10 according to the embodiment of the invention, since a large magnitude of negative pressure can be generated in the concave portion 132 of the cap 130 by operating the two suction pumps 150, even when the viscosity of the ink in the head assembly 24 has increased, it can be returned to a normal state. Since after the cleaning operation, one suction pump 150b can be in a reversible state with the other suction pump 150a is being operated, an air sucking operation can be started after the negative pressure in the concave portion 132 is reduced by reversing the ink in the suction pump 150b. As a result, there will be no problems in the normal ejection of the ink due to the inflow of air with a rush which causes the generation of bubbles in the concave portion 132 and the bubbles being mixed in the ejection nozzle.

If the suction pump 150b is brought into a reversible state to perform an air sucking operation, since the ink in the suction pump 150b is automatically reversed to reduce the magnitude of the negative pressure in the concave portion 132 of the cap 130, a particular operation is not needed to reduce the magnitude of the negative pressure in the concave portion 132 of the cap 130 and the structure and control of the inkjet printer 10 does not become complicated.

Although the exemplary embodiment of the invention has been described with reference to the accompanying drawings, it should be understood that the invention is not limited to such embodiments. Various shapes or combinations of respective constituent elements illustrated in the above-described embodiments are merely examples, and various changes may be made depending on design requirements or the like without departing from the spirit or scope of the invention.

For example, the embodiment of the invention illustrates a so-called serial printer that prints an image with a head assembly 24 reciprocating on printing paper. However, the present invention can be applied to so-called line printers that print an image by transporting printing paper with the head assembly 24 not being moved.

The entire disclosure of Japanese Patent Application No. 2008-189459, filed Jul. 23, 2008 is expressly incorporated by reference herein.

What is claimed is:

1. A fluid ejection apparatus that ejects a fluid from an ejection nozzle formed in an ejection head, comprising:
a fluid receiver that has a concave portion for accommodating the fluid from the ejection nozzle, and defines a closed space around the ejection nozzle when the concave portion comes in contact with the ejection head;
a plurality of suction pumps that suck the fluid in the concave portion of the fluid receiver through suction ports provided in the concave portion of the fluid receiver;
a fluid suction unit that sucks the fluid in the ejection head through the ejection nozzle by operating the suction pumps in a state in which the concave portion of the fluid receiver comes in contact with the ejection head; and an air suction unit that, after completion of suction of the fluid in the ejection head, sucks the air together with the fluid in the concave portion of the fluid receiver by allowing at least one suction pump to reverse the air flow in collaboration with the operating of at least one other suction pump.

2. The fluid ejection apparatus according to claim 1, further comprising:
a waste fluid tank that stores the fluid sucked from the ejection nozzle; and
a plurality of waste fluid tubes, each of which one end is connected to a discharge port of the suction pump and the other end is inserted into the waste fluid tank.

3. The fluid ejection apparatus according to claim 2, wherein the waste fluid tube of the suction pump, which is able to reverse air flow when air is being sucked, is inserted into the waste fluid tank in a shallower position than the waste fluid tube of another suction pump.
